(19) United States
(12) Patent Application Publication
(10) Pub. No.: US 2005/0107113 A1
(43) Pub. Date: May 19, 2005

(54) Method of controlling radio links in a radiocommunication system and control unit for applying the method

(75) Inventors: Marthe Laune, Paris (FR); Stephane Cayla, Viroflay (FR)

Correspondence Address: PIPER RUDNICK, P. O. BOX 64807, CHICAGO, IL, 60664-0807, US

(73) Assignee: NORTEL NETWORKS LIMITED

(21) Appl. No.: 10/829,707

(22) Filed: Apr. 21, 2004

(30) Foreign Application Priority Data
Apr. 25, 2003 (FR) 03 05110

(51) Int. Cl. H04B 15/00

(52) U.S. Cl. 455/550.1

(57) ABSTRACT

In a radiocommunication system, the data exchanged are protected against transmission errors according to a protection scheme selected by taking account of an indication according to which a transition from a protection scheme is authorized or forbidden. For at least one base station of said system: for the mobile stations having respective radio links with said base station, measurements are taken of the parameters relative to conditions of propagation on said radio links and between said mobile stations and at least one base station adjacent to said base station; the indication relative to the transitions for the radio links with the base station is updated so that at least one transition is considered to be authorized if a criterion, a function of the measured parameters, is satisfied, and forbidden if said criterion is not satisfied.

### BACKGROUND OF THE INVENTION

The present invention relates to a method of controlling radio links in a radiocommunication system. More particularly it relates to the method of protecting radio links against transmission errors.

Certain radiocommunication systems comprise different levels of protection against errors in the transmitted data. The GPRS (General Packet Radio Service) system, for example, makes it possible to transmit, between a base station and a mobile station, blocks of modulated signal that may receive variable protection against transmission errors. The level of protection is selected block by block through the choice of one coding scheme CS out of four schemes CS-1 to CS-4 specified in European standard ETSI EN 300 909, Digital cellular telecommunications system (Phase 2+); Channel coding (GSM 05.03, version 8.5.1, Release 1999), published by the ETSI (European Telecommunications Standards Institute) in November 2000. The coding scheme CS-1 is the most robust against transmission errors, but also the one which authorizes the lowest effective bit rate for the data transmission to which it is assigned. Conversely, the coding scheme CS-4 is the least robust against errors, since it contains no particular protection, but is also the one that authorizes the highest effective transmission rate.

A control unit, called the PCU (Packet Control Unit) is most frequently responsible for choosing a coding scheme. The choice may be based on an optimization of the data rate offered for each transmission and must take account of the transmission conditions between the stations concerned. Thus, if the transmission quality is mediocre on the radio channels used, it will be preferable to use a robust scheme to ensure that the data are transmitted. On the other hand, if the conditions of propagation are not tainted by errors, it will be wise to choose a scheme that favours the data transmission rate. Such a choice may be made during a call, giving rise to the selection of a new coding scheme more suitable than the old one.

To do this, the control unit may use as a basis a certain number of measurements representative of the transmission quality which are sent to it by the base stations for the radio uplinks (mobile station to base station), and/or by the mobile stations for the radio downlinks (base station to mobile station).

However, the measurements provided in the GPRS system in particular are limited and ill-suited to the requirements of packet mode data transmission. As an example, these measurements are imprecise to the point that they do not allow the PCU effectively to choose between certain coding schemes, such as between CS-3 and CS-4 for example. If the measurements taken indicate that the radio conditions are intermittently favourable on a radio link, CS-4 may be selected for this link. However, in the event of a sudden deterioration of the radio conditions, the frequency of the measurements is occasionally insufficient for the PCU to select a more robust coding scheme in a reactive manner, which may lead to the loss of the call in progress on the radio link in question.

In addition, the measurements provided in the GPRS system do not of themselves allow the precise determination of the transition thresholds between coding schemes, so these thresholds have to be established based on manual measurements that are all the more complex since they should ideally be carried out in the service zone of each base station of the network used.

This situation has led certain radiocommunication systems operators to disable the coding scheme changes by fixing one coding scheme for all the radio links (often CS-2). Such a method of operation is sub-optimal both in terms of protection against transmission errors and of effective bit rate since it does not take account of the variations of the propagation conditions over time or of the local specific features of the network (frequency plan, base station configuration, urban or rural type of environment, etc.).

One object of the present invention is to limit the abovementioned drawbacks, in order to obtain a good compromise between the effective bit rate of the data transmissions and the protection of the data against transmission errors.

Another object of the invention is to allow a dynamic selection of the protection level for the radio links, based on criteria that are more reliable than the usual simple measurements and that avoid having to carry out cumbersome campaigns of network qualification measurements.

### SUMMARY OF THE INVENTION

Thus the invention proposes a method of controlling radio links in a radiocommunication system comprising base stations and mobile stations, each mobile station being disposed to maintain a radio link with a serving base station out of said base stations and to receive signals transmitted by base stations adjacent to the serving station out of said base stations, the radio links supporting signals, representing data protected against transmission errors according to a protection scheme selected from several determined protection schemes, the selection of one protection scheme on a radio link taking account of an indication according to which a transition from a protection scheme previously allocated to said radio link is authorized or forbidden, the method comprising the following steps for at least one base station of the radiocommunication system:
measurement, for the mobile stations having respective radio links with said base station, of parameters relating to conditions of propagation on said radio links on the one hand and of parameters relating to conditions of propagation between said mobile stations and at least one base station adjacent to said base station on the other hand;
updating of the indication relative to the transitions for the radio links with said base station, so that at least one transition is considered to be authorized if a criterion, a function of the measured parameters, is satisfied, and forbidden if said criterion is not satisfied.

Such a method in particular makes it possible to avoid transitions which may adversely affect the quality of the corresponding radio links, in light of the radio environment. Conversely, it makes it possible to authorize transitions which present few risks to the quality of the radio links.

The criterion serving as the basis for the decision to authorize or forbid a transition for all the radio links with the base station is advantageously an estimate of a signal-to-noise ratio in which the interference is, where necessary, overassessed to reduce the risks of taking an inadequate decision.

This criterion may cause the involvement of a parameter that is subject to a statistical analysis over an observation period. This analysis may be carried out once and for all or on a regular basis, particularly to take account of network modifications.

The invention also proposes a control unit in a radiocommunication system comprising base stations and mobile stations, each mobile station being disposed to maintain a radio link with a serving base station out of said base stations and to receive signals transmitted by base stations adjacent to the serving station out of said base stations, the radio links supporting signals, representing data, the control unit comprising means for protecting the data against transmission errors by applying to them, on the corresponding radio link, a protection scheme which it selects from several determined protection schemes while taking account of an indication according to which a transition from a protection scheme previously allocated to said radio link is authorized or forbidden, the control unit also comprising:
means for obtaining a criterion on the basis of measurements, for mobile stations having respective radio links with at least one base station of the radiocommunication system, of parameters relating to conditions of propagation on said radio links on the one hand and of parameters relating to conditions of propagation between said mobile stations and at least one base station adjacent to said base station on the other hand;
means for updating the indication relative to the transitions for the radio links with said base station, comprising means for considering at least one transition to be authorized if said criterion is satisfied, and to be forbidden if said criterion is not satisfied.

### BRIEF DESCRIPTION OF THE DRAWINGS

FIG. 1 is a diagram of a network of the GPRS type to which the invention may apply;

FIG. 2 is a block diagram of a packet control unit of such a network, suited to the application of the invention;

FIG. 3 is a simplified architecture diagram of a radio network applying the invention.

### DESCRIPTION OF PREFERRED EMBODIMENTS

The invention is described hereinafter in its non-exclusive application to GPRS networks. These networks have been developed to allow the transmission of data in packet mode in cellular networks of the GSM (Global System for Mobile communications) type. Special consideration will be given to packet transmission in the downlink direction, that is to say from the network infrastructure to the mobile stations.

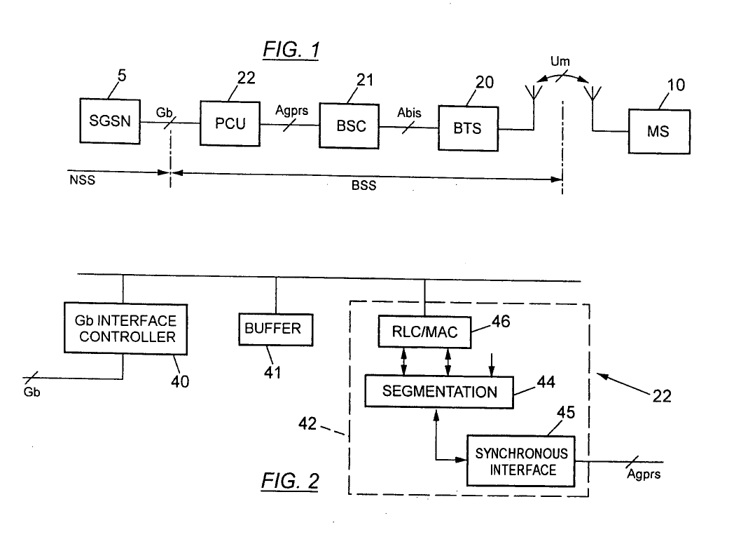

The GPRS network illustrated in FIG. 1 is built on a GSM infrastructure, and conventionally divided into a network core, also called Network and Switching Subsystem (NSS), and a radio access network, also called a Base Station Subsystem (BSS).

For the packet service, the NSS switches are called GPRS support nodes or GSNs. A distinction is made between SGSNs (serving GSNs) 5 which are connected to the BSS via an interface called Gb and GGSNs (gateway GSNs, not shown) which serve as a gateway with outside packet transmission networks, such as the Internet network for example.

A general description of the radio interface, called the Um, between the mobile stations (MS) 10 and the base stations (BTS) 20 of the BSS is supplied in technical specification ETSI TS 101 350, “Digital cellular telecommunications system (Phase 2+); General Packet Radio Service (GPRS); Overall description of the GPRS radio interface; Stage 2 (GSM 03.64, version 8.5.0, Release 1999), published by the ETSI (European Telecommunications Standards Institute) in August 2000.

Each base station 20 is supervised by a base station controller or BSC 21 via an interface called Abis. To manage the transmission of GPRS packets, the BSS also comprises a packet control unit (PCU) 22. The location of the PCU inside the BSS is not standardized. In the example shown in FIG. 1, the PCU 22 is situated between the BSC 21, with which it communicates over an interface called Agprs, and the NSS, with which it communicates via the Gb interface.

FIG. 2 illustrates a possible structure of a PCU 22 situated between an SGSN 5 and a BSC 21, as in the example in FIG. 1. The reference 40 denotes the Gb interface controller for the link with the SGSN 5.

The Gb interface is of the asynchronous type. It is based on the frame relay (FR) protocol and also on a protocol called BSSGP (BSS GPRS Protocol) which transports routing and quality of service information between the BSS and the SGSN. The Gb interface controller 40 provides the physical link with the SGSN 5 and the procedures specific to the FR and BSSGP protocols.

The links between the PCU 22 and the BTS 20 via the Agprs interface are of the synchronous type. Consequently, the data handled by the PCU 22 between the Gb interface controller 40 and the Agprs interface controller 42 pass through a buffer memory 41 in which the queues of packets are registered.

Between the PCU 22 and the BTS 20, the information is carried by 320-bit frames of the TRAU (Transcoder/Rate Adapter Unit) type. These TRAU frames are formatted and processed by a module 44 and transmitted via synchronous interface circuits 45 which produce 16 kbit/s PCM subchannels with the BTSs 20. In GSM systems, the 64 kbit/s channels (DS0) are usually subdivided into four sub-channels each dedicated to one physical channel on the radio. Several 16 kbit/s channels (sub-channels) are multiplexed in time over the Agprs interface and switched by the BSC 21 for routing to the BTSs.

A module 46 of the Agprs interface controller 42 applies the radio protocols of the layer 2 of the ISO model, that is the RLC/MAC (Radio Link Control/Medium Access Control) protocols described in European standard ETSI EN 301 349, Digital cellular telecommunications system (Phase 2+); General Packet Radio Service (GPRS); Mobile Station (MS)—Base Station System (BSS) interface; Radio Link Control/Medium Access Control (RLC/MAC) protocol (GSM 04.60, version 8.3.1, Release 1999) published by the ETSI in October 2000.

The RLC sub-layer provides the interface with the higher layer protocol, called the LLC (Logical Link Control). It provides the segmentation and reassembly of the data links of the LLC protocol (LLC-PDU), which are interchanged asynchronously over the Gb interface. It produces blocks of RLC data to which the MAC sub-layer adds an MAC header of one byte.

In the downlink direction, from the PCU to the MSs, the MAC header of each RLC/MAC block includes:
a three-bit USF (Uplink State Flag) field, serving to indicate which mobile station is authorized to use an uplink resource corresponding to the downlink resource on which the RLC/MAC block is transmitted;
a three-bit acknowledgement control field, including a one-bit S/P (Supplementary/Polling) sub-field indicating whether the acknowledgement control field is active (S/P=1) or inactive (S/P=0) and a two-bit RRBP (Relative Reserved Block Period) sub-field specifying in a unique manner an uplink block in which the destination mobile station must transmit an acknowledgement message;
a two-bit “Payload Type” field specifying the next type of RLC block (data, control, etc.).

What is of interest here is the transmission of RLC data blocks. Each of these blocks comprises an RLC header following the MAC header byte. This RLC header comprises in particular the following information:
temporary flow identity (TFI), consisting of five bits identifying the temporary block flow (TBF) from whence the RLC data of the block come. A TBF is a connection supporting the unidirectional transfer of LLC-PDU on physical data channels. A TBF is temporary, that is to say it is maintained only during the data transfer;
a block sequence number BSN of SNS bits, which contains the sequence number of the RLC/MAC block in the TBF, modulo 2^{SNS}, SNS being a predefined number.

The MAC sub-layer also manages the multiplexing of the blocks arising from the various active TBFs on the available physical channels, by arbitrating between the different mobile users through a scheduling mechanism.

In the case of the GPRS, a variable level of protection against transmission errors on the radio may be selected block by block within a TBF, by the choice of a coding scheme (CS) out of four schemes CS-1 to CS-4 specified in European standard ETSI EN 300 909, Digital cellular telecommunications system (Phase 2+); Channel coding (GSM 05.03, version 8.5.1, Release 1999), published by the ETSI in November 2000.

The scheme CS-4 does not use an error correcting code, that is to say that the coding efficiency is 1: only a block check sequence (BCS) is added to the data blocks. The schemes CS-1 to CS-3 use a convolutional code with an efficiency of ½ after the addition of the BCS sequence. No puncturing is carried out in the scheme CS-1 (which offers the highest level of protection), whereas puncturing is applied in schemes CS-2 and CS-3 so that they give rise to global coding efficiencies of approximately 2/3 and approximately 3/4 respectively.

The coding of channel CS-i (1≦i≦4) is applied to the physical layer protocol, that is to say in the BTSs for the downlinks. Each BTS has at least one transceiver unit (TRX) handling eight multiplexed physical channels. These eight physical channels are multiplexed using TDMA (Time-Division Multiple Access) with successive frames of 4.615 ms each broken down into eight time divisions. One physical channel corresponds to time divisions of corresponding rank in the frame structure. The transmission frequency on such a channel can be fixed or variable from one frame to the other if a frequency hop method is applied. Each RLC/MAC block gives rise to a radio block which, after the channel coding in a TRX unit, consists of 456 bits transmitted in corresponding time divisions of four-consecutive TDMA frames. The 114 bits of coded information of each time division are modulated to be transmitted over the radio interface according to a two-state phase shift modulation of the GMSK (Gaussian Minimum Shift Keying) type.

For a physical data channel (PDCH), a multiframe lasts 240 ms and consists of 52 TDMA frames of which four are inactive or used for the transmission of control information. There are thus twelve radio blocks per multiframe, that is one radio block every 20 ms.

A pattern of eight signalling bits SB is inserted into each radio block (two bits per time division) in order in particular to indicate which coding scheme has been applied by the transmitter.

These signalling bits are extracted from the coded block received by the recipient, so that said recipient can identify the coding scheme. The receiver then proceeds with the appropriate decoding of the block which may give rise to a positive acknowledgement if it is successful and if the decoded BCS is consistent with the content of the block.

Table I indicates the data rates offered by the coding schemes CS-1 to CS-4 of a GPRS system.

TABLE I

| Scheme | Rate (kbit/s) |
|---|---|
| CS-1 | 9.05 |
| CS-2 | 13.4 |
| CS-3 | 15.6 |
| CS-4 | 21.4 |

The coding diagram applied on the downlink is determined by the PCU on the basis of reception quality measurements on the radio link. Such a determination may use link adaptation mechanisms known per se, which seek to achieve an objective in terms of errored block rate in order to optimize the gross data rate. The selected scheme is inserted into the TRAU frame carrying the block to be applied by the BTS.

The coding scheme applied may be modified during a call on a radio link, particularly when the measurements taken on the link identify changes in reception quality.

According to the invention, the PCU authorizes transitions between some protection schemes and forbids others. It may store, for each base station under its responsibility, an indication of authorized or forbidden transitions, such that, when the need for a change of protection scheme is detected, the determination of the new protection scheme takes it into account. For example, since the transition between CS-3 and CS-4 (that is to say from CS-3 to CS-4 and from CS-4 to CS-3) is difficult to manage, as explained in the introduction, on the basis of the reception quality measurements on a radio link, it may advantageously be forbidden.

Thus, a radio link using CS-3 will not be able to be assigned CS-4 to continue its call, even if the radio conditions are more favourable. This inhibition is used to avoid taking an inappropriate decision which might place the call in danger if the improvement in the radio conditions turns out to be inexact or short-lived. Similarly, the transition from CS-4 to CS-3 for a radio link may also be considered to be forbidden where appropriate. Conversely, other transitions between protection schemes are considered by the PCU to be authorized: for example, transitions between CS-1 and CS-2.

The indication according to which a transition between protection schemes is authorized or forbidden may also be modified in certain conditions, as will be described below.

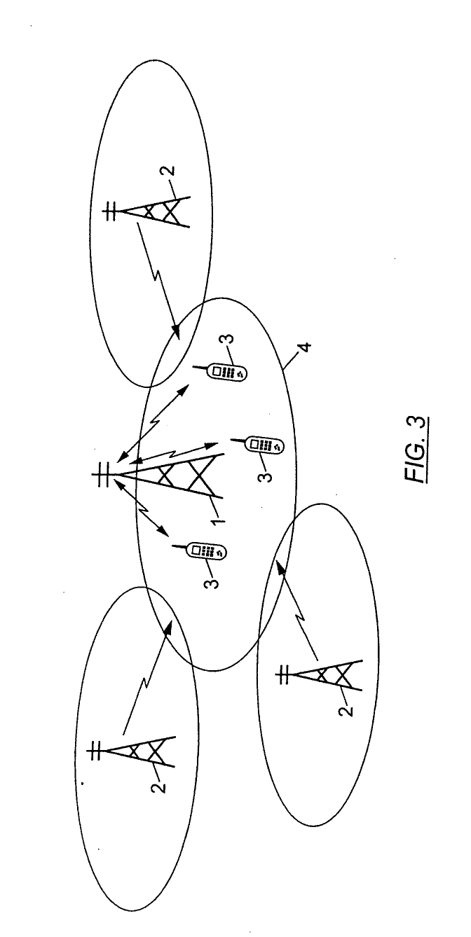

FIG. 3 illustrates an example of a radio network for the application of the invention. In this example, a BTS 1 is in communication, on respective radio links, with MSs 3 that are in its service zone 4. The BTS 1 thus sends signals carrying the data to be transmitted to the various MSs 3. According to a conventional power control mechanism, the BTS 1 can reduce the power of its transmission to one or more MSs 3, relative to a maximum power value, depending on the radio conditions on each link. This power attenuation in dB is identified by Att_pwc.

Furthermore, the MSs 3 take measurements of the reception quality on the respective links they support with the BTS 1 in a manner known per se. In particular, each MS 3 records a signal level received from the BTS 1, as is described for example in section 8.1 of technical specification 100 911, version 5.10.0, “Radio Subsystem Link Control”, (Release 1996), published in September 2000 by the ETSI (European Telecommunications Standards Institute). The signal level measured in dBm is identified as RxLev_DL. A measurement report is made regularly to the network, according to section 8.4 of technical specification 100 911.

In parallel with the measurements taken on the signals from the BTS 1, which serves the cell 4 containing the MSs 3, the MSs also measure the signal level from the BTSs 2 of the adjacent cells, in a manner known per se. The signal level in dBm measured by an MS 3 from a BTS 2 of an adjacent cell i out of the adjacent cells declared for the BTS 1 is identified as RxLev_Ncell(i). In the same manner as for RxLev_DL, the RxLev_Ncell(i) recorded are transferred to the network by each MS 3 so that they can be processed there.

The various measurements evoked above are transmitted to the network where they are the subject of a processing operation. This processing operation advantageously consists in calculating, for each set of measurements uploaded by MSs 3, a parameter Clbgt equal to:

$$Clbgt = ( RxLev\_DL + Att\_pwc ) - {\sum }_{i} ( RxLev\_Ncell ( i ) ) .$$

Clbgt thus represents a difference between the effective signal originating from the BTS 1 and a level of interference, represented by a linear sum of interferer signals, which makes the assumption that all the declared adjacent cells of the BTS 1 use the same frequency. This parameter therefore constitutes a worst case and does not depend on the currently applicable frequency plan, that is to say on the distribution of the frequencies allocated in the network. This parameter is advantageously obtained from all the MSs 3 in the service zone 4 of the BTS 1, even if they do not support the GPRS functionality, since the abovementioned measurements are also taken for simple GSM terminals without GPRS capability.

The parameter Clbgt can be computed by the PCU on which the BTS 1 depends or, if it is computed by another entity, such as the BSC that controls the BTS 1 or the BTS 1 itself, it can be transmitted to the PCU.

A cumulated distribution of the parameter Clbgt can thus be obtained over an observation time period. The cell 4 can be qualified according to this distribution. Specifically, a high proportion of samples having a low value signifies that the level of interference is globally high in comparison with the effective signal. Conversely, a high proportion of samples having a high value signifies a favourable signal-to-interference ratio. If the cumulated distribution is obtained in the BSC which controls the BTS 1 or in the BTS 1 itself, this distribution can be transmitted to the PCU.

Advantageously, a threshold is defined for the parameter Clbgt, for example 12 dB. Depending on the proportion of samples in the cumulated distribution that exceeds this threshold, the PCU may then decide to modify certain authorizations or inhibitions of transitions between coding schemes. As an illustration, the transition between CS-2 and CS-4 (that is to say from CS-2 to CS-4 or from CS-4 to CS-2) can be considered to be authorized if 95% of the samples of the parameter Clbgt are above the threshold. Specifically, in this case, the effective signal is predominant relative to the maximum interference. A transition from CS-2 to CS-4 for calls of the MSs 3 with the BTS 1 does not present any major risk in the short term. On the other hand, if the trend is reversed and the proportion of Clbgt above the threshold is low, for example less than 95%, the PCU may forbid the transition between CS-2 and CS-4. In the same manner, the transition between CS-2 and CS-3 may advantageously be the subject of an authorization or inhibition indication.

According to one variant, the transition being authorized or forbidden concerns the transition from a first coding scheme to a second coding scheme less robust than the first, whereas the converse transition from the second to the first coding scheme is managed independently. For example, the transition from CS-2 to CS-4 may be inhibited, whereas the transition from CS-4 to CS-2 remains possible.

The qualification of a cell may be made once and for all in order to determine the transitions between protection schemes that may be applied in it. In another mode of operation, the qualification is updated regularly during a new observation period. Such an update is useful in particular for taking account of a new network configuration close to the BTS in question (for example when a BTS is added) or when there is a modification of the adjacent cells declared for that BTS.

As indicated above, the parameter Clbgt is of value to the extent that it represents a worst case of the signal-to-interference ratio. However, any other parameter based on the radio measurements transmitted to the network and used to qualify a cell may equally be used to define a quality criterion of the cell, based on which transitions between protection schemes will be authorized or forbidden.

Furthermore, systems other than the GPRS may use protection schemes to transmit data. Likewise, an appropriate criterion may be defined according to the invention to allow some transitions between protection schemes and to forbid others.

1. Method of controlling radio links in a radiocommunication system comprising base stations and mobile stations, each mobile station being disposed to maintain a radio link with a serving base station out of said base stations and to receive signals transmitted by base stations adjacent to the serving station out of said base stations, the radio links supporting signals, representing data protected against transmission errors according to a protection scheme selected from several determined protection schemes, the selection of one protection scheme on a radio link taking account of an indication according to which a transition from a protection scheme previously allocated to said radio link is authorized or forbidden, the method comprising the following steps for at least one base station of the radiocommunication system:
measurement, for the mobile stations having respective radio links with said base station, of parameters relating to conditions of propagation on said radio links on the one hand and of parameters relating to conditions of propagation between said mobile stations and at least one base station adjacent to said base station on the other hand;
updating of the indication relative to the transitions for the radio links with said base station, so that at least one transition is considered to be authorized if a criterion, a function of the measured parameters, is satisfied, and forbidden if said criterion is not satisfied.

2. Method according to claim 1, in which the parameters relating to conditions of propagation comprise signal levels transmitted by said base station on the one hand and by the base stations adjacent to said base station on the other hand and in which the measurement of said parameters is carried out by said mobile stations.

3. Method according to claim 1, in which the criterion is satisfied when a distribution cumulated over a period of observation time for a parameter equal to
$$( RxLev\_DL + Att\_pwc ) - {\sum }_{i} ( RxLev\_Ncell ( i ) )$$
comprises a proportion of samples greater than a threshold, where RxLev_DL represents a signal level transmitted by said base station measured by the mobile stations, Att_pwc represents an attenuation of the signal transmitted by said base station on transmission and RxLev_Ncell(i) represents a signal level transmitted by the base station i adjacent to said base station measured by the mobile stations.

4. Method according to claim 3, in which the cumulated distribution is updated periodically.

5. Method according to claim 1, in which the transition considered to be authorized or forbidden when the indication relating to the transitions is updated is a transition from a first protection scheme to a second protection scheme less robust than the first protection scheme.

6. Method according to claim 1, in which the radiocommunication system supports the GPRS (General Packet Radio Service) and in which a protection scheme is selected from four protection schemes of the GPRS, respectively CS-1 to CS-4.

7. Method according to claim 6, in which the transition from CS-3 to CS-4 and the transition from CS-4 to CS-3 are forbidden.

8. Method according to claim 6, in which the transition considered to be authorized if a criterion is satisfied, and forbidden if said criterion is not satisfied, is a transition between CS-2 and CS-4.

9. Method according to claim 6, in which the transition considered to be authorized if a criterion is satisfied, and forbidden if said criterion is not satisfied, is a transition between CS-2 and CS-3.

10. Control unit in a radiocommunication system comprising base stations and mobile stations, each mobile station being disposed to maintain a radio link with a serving base station out of said base stations and to receive signals transmitted by base stations adjacent to the serving station out of said base stations, the radio links supporting signals, representing data, the control unit comprising means for protecting the data against transmission errors by applying to them, on the corresponding radio link, a protection scheme which it selects from several determined protection schemes while taking account of an indication according to which a transition from a protection scheme previously allocated to said radio link is authorized or forbidden, the control unit also comprising:
means for obtaining a criterion on the basis of measurements, for mobile stations having respective radio links with at least one base station of the radiocommunication system, of parameters relating to conditions of propagation on said radio links on the one hand and of parameters relating to conditions of propagation between said mobile stations and at least one base station adjacent to said base station on the other hand;
means for updating the indication relative to the transitions for the radio links with said base station, comprising means for considering at least one transition to be authorized if said criterion is satisfied, and to be forbidden if said criterion is not satisfied.

11. Control unit according to claim 10, in which the parameters relating to conditions of propagation comprise signal levels transmitted by said base station on the one hand and by the base stations adjacent to said base station on the other hand, in which the measurements of said parameters are taken by said mobile stations, the control unit comprising means for receiving the measurements of said parameters from said mobile stations.

12. Control unit according to claim 10, also comprising means for computing a distribution cumulated over a period of observation time for a parameter equal to
$$( RxLev\_DL + Att\_pwc ) - {\sum }_{i} ( RxLev\_Ncell ( i ) ) ,$$
in which RxLev_DL represents a signal level transmitted by said base station measured by the mobile stations, Att_pwc represents an attenuation of the signal transmitted by said base station on transmission and RxLev_Ncell(i) represents a signal level transmitted by the base station i adjacent to said base station measured by the mobile stations and in which said criterion is satisfied when the cumulated distribution comprises a proportion of samples greater than a threshold.

13. Control unit according to claim 12, comprising means for periodically updating the cumulated distribution.

14. Control unit according to claim 10, in which the transition concerned by the means for considering at least one transition to be authorized if said criterion is satisfied, and to be forbidden if said criterion is not satisfied, is a transition from a first protection scheme to a second protection scheme less robust than the first protection scheme.

15. Control unit according to claim 10, in which the radiocommunication system supports the GPRS (General Packet Radio Service), and in which the determined protection schemes from which the control unit selects a protection scheme are the four protection schemes of the GPRS, respectively CS-1 to CS-4.

16. Control unit according to claim 15, in which the means for considering at least one transition to be authorized if said criterion is satisfied, and to be forbidden if said criterion is not satisfied, consider the transition from CS-3 to CS-4 and the transition from CS-4 to CS-3 to be forbidden.

17. Control unit according to claim 15, in which the means for considering at least one transition to be authorized if said criterion is satisfied, and to be forbidden if said criterion is not satisfied, concern a transition between CS-2 and CS-4.

18. Control unit according to claim 15, in which the means for considering at least one transition to be authorized if said criterion is satisfied, and to be forbidden if said criterion is not satisfied, concern a transition between CS-2 and CS-3.
